(19) United States
(12) Patent Application Publication
(10) Pub. No.: US 2023/0351436 A1
(43) Pub. Date: Nov. 2, 2023

(54) ADVERTISING EFFECT PREDICTION DEVICE

(71) Applicant: NTT DOCOMO, INC., Chiyoda-ku (JP)

(72) Inventors: Sayuri HASHIMOTO, Chiyoda-ku (JP); Yusuke FUKAZAWA, Chiyoda-ku (JP); Tsukasa DEMIZU, Chiyoda-ku (JP); Takahito ISHII, Chiyoda-ku (JP)

(73) Assignee: NTT DOCOMO, INC., Chiyoda-ku (JP)

(21) Appl. No.: 18/040,873

(22) PCT Filed: Aug. 17, 2021
(86) PCT No.: PCT/JP2021/030059

§ 371 Date: Feb. 7, 2023

(30) Foreign Application Priority Data
Aug. 26, 2020 (JP) 2020-142768

(51) Int. Cl. G06Q 30/0242

(52) U.S. Cl. CPC G06Q 30/0242

(57) ABSTRACT

An advertising effect prediction device is a device that predicts an advertising effect of advertising content, and includes: an acquisition unit that acquires advertisement information related to the advertising content; and a calculation unit that calculates the advertising effect based on the advertisement information. The advertisement information includes a plurality of images included in the advertising content, and the calculation unit calculates the advertising effect based on an arrangement order of the plurality of images in the advertising content.

### TECHNICAL FIELD

The present disclosure relates to an advertising effect prediction device.

### BACKGROUND ART

In recent years, an advertisement including a link for transition to a web page of an advertiser has been distributed. The effect of such an advertisement is indicated by indexes such as a click rate and a conversion rate. Patent Literature 1 describes an advertising effect estimation model that inputs one advertisement image and outputs advertising effects such as a click rate and a conversion rate.

### CITATION LIST

### Patent Literature

Patent Literature 1: Japanese Unexamined Patent Publication No. 2018-77615

### SUMMARY OF INVENTION

### Technical Problem

The advertisement may include a plurality of images. In the advertising effect estimation model described in Patent Literature 1, since only one image can be input, a plurality of images cannot be considered. For such an advertisement, it is desired to more accurately predict an advertising effect.

The present disclosure describes an advertising effect prediction device capable of improving prediction accuracy of an advertising effect.

### Solution to Problem

An advertising effect prediction device according to an aspect of the present disclosure is a device that predicts an advertising effect of advertising content. The advertising effect prediction device includes: an acquisition unit that acquires advertisement information related to the advertising content; and a calculation unit that calculates the advertising effect based on the advertisement information. The advertisement information includes a plurality of images included in the advertising content. The calculation unit calculates the advertising effect based on an arrangement order of the plurality of images in the advertising content.

In the advertising effect prediction device, the advertising effect is calculated based on the arrangement order of the plurality of images in the advertising content. It is considered that the delivery target person who receives the delivery of the advertising content views the advertising content in order from the head. Therefore, there is a high possibility that the plurality of images included in the advertising content are within the field of view of the delivery target person in the arrangement order in the advertising content. In such a case, it is considered that the arrangement order of the images affects the interest of the delivery target person. In the advertising effect prediction device, since the advertising effect is predicted in consideration of the arrangement order of the plurality of images in the advertising content, it is possible to improve the prediction accuracy of the advertising effect of the advertising content.

### Advantageous Effects of Invention

According to the present disclosure, it is possible to improve prediction accuracy of an advertising effect.

### BRIEF DESCRIPTION OF DRAWINGS

FIG. 1 is a block diagram showing a functional configuration of an advertising effect prediction device according to an embodiment.

FIG. 2 is a diagram for explaining an image acquisition process and an image processing process.

FIG. 3 is a diagram showing a configuration of a prediction model.

FIG. 4 is a diagram for explaining the model for image shown in FIG. 3.

FIG. 5 is a diagram for explaining a configuration of the convolutional long short-term memory (LSTM) shown in FIG. 4.

FIG. 6 is a flowchart showing a series of processes of an advertising effect prediction method performed by the advertising effect prediction device shown in FIG. 1.

FIG. 7(a) is a diagram showing a relationship between the CTR predicted by the advertising effect prediction device shown in FIG. 1 and the actual CTR. FIG. 7(b) is a diagram showing a relationship between the CTR predicted by an advertising effect prediction device of a comparative example and the actual CTR.

FIG. 8 is a diagram showing a hardware configuration of the advertising effect prediction device shown in FIG. 1.

### DESCRIPTION OF EMBODIMENTS

In the following, embodiments of the present disclosure will be described with reference to the drawings. It should be noted that in the description of the drawings, the same components are designated with the same reference signs, and the redundant description is omitted.

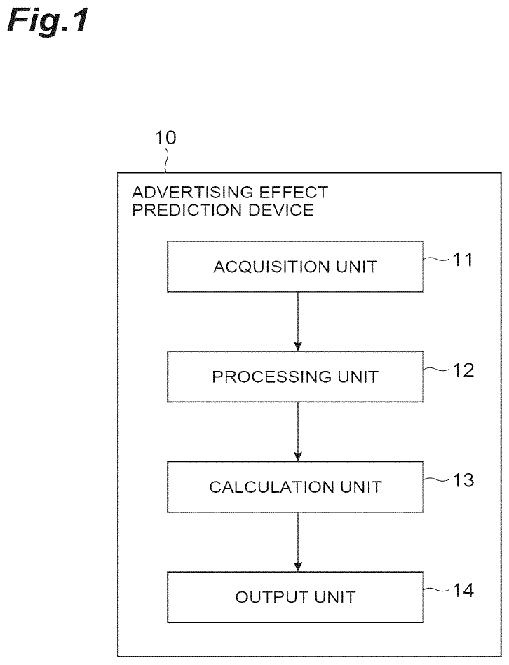

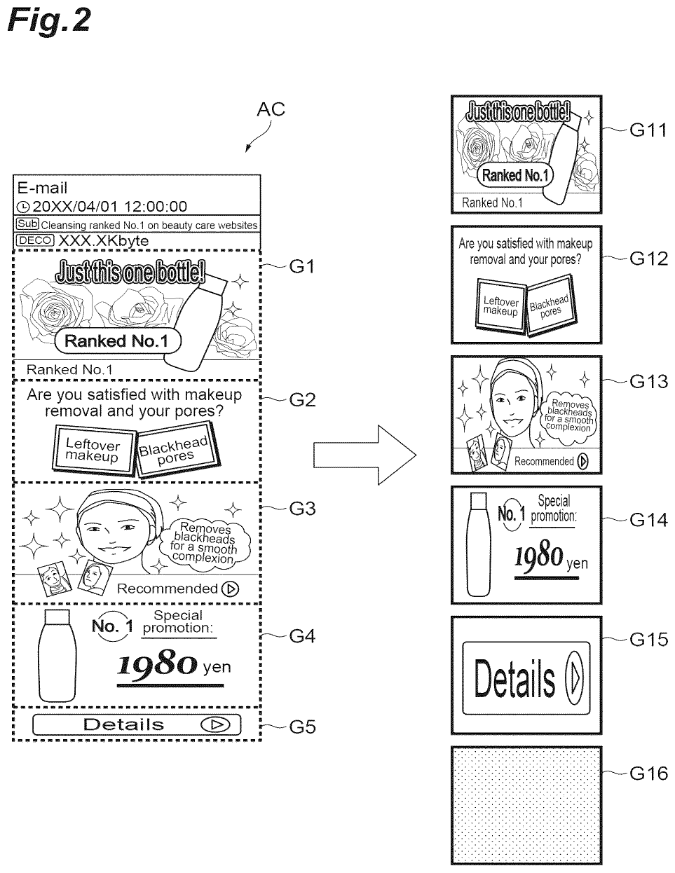

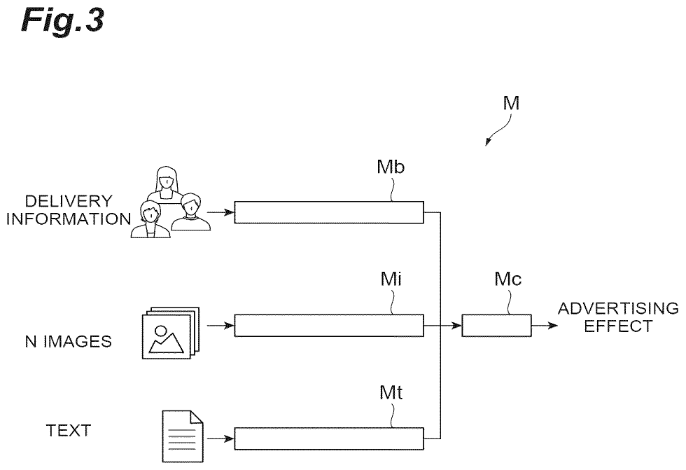

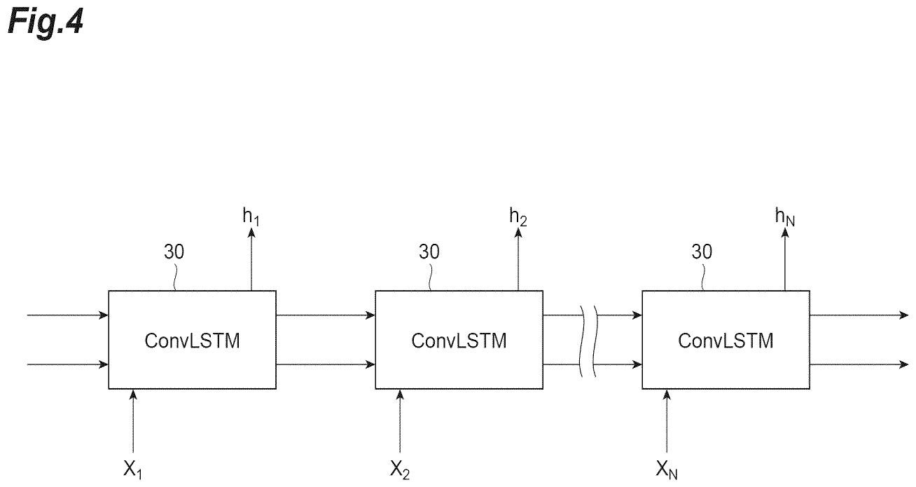

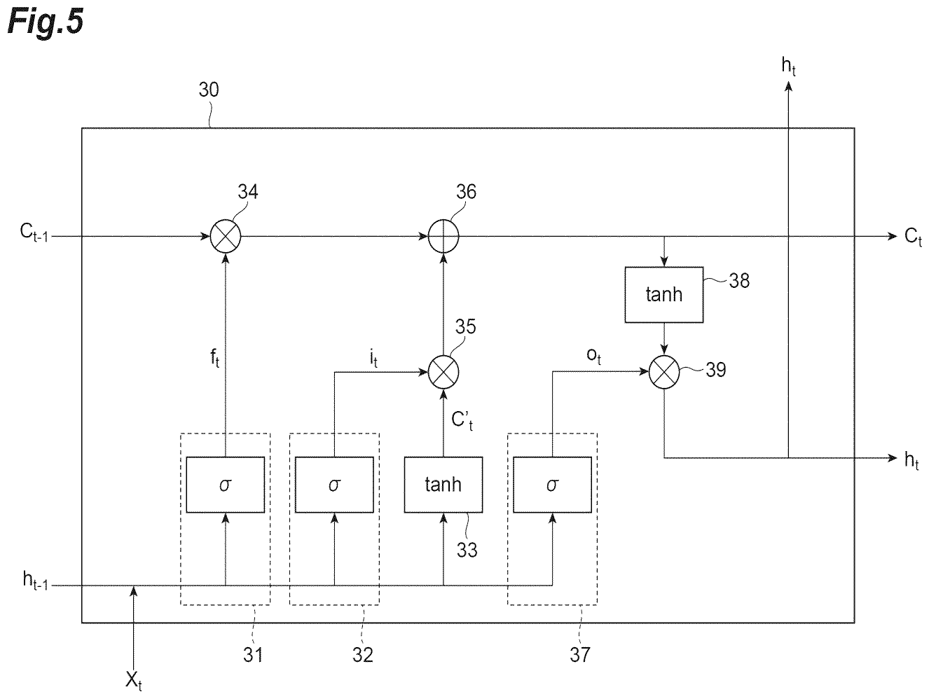

A configuration of an advertising effect prediction device according to an embodiment will be described with reference to FIGS. 1 to 5. FIG. 1 is a block diagram showing a functional configuration of an advertising effect prediction device according to an embodiment. FIG. 2 is a diagram for explaining an image acquisition process and an image processing process. FIG. 3 is a diagram showing a configuration of a prediction model. FIG. 4 is a diagram for explaining the model for image shown in FIG. 3. FIG. 5 is a diagram for explaining a configuration of the convolutional LSTM shown in FIG. 4.

An advertising effect prediction device 10 shown in FIG. 1 is a device that predicts an advertising effect of advertising content (advertisement original). The advertising content includes, for example, an image and text. An example of advertising content is an advertisement delivered by e-mail. The advertising content is described in, for example, HyperText Markup Language (HTML). Examples of the index indicating the advertising effect include a click through rate (CTR), a conversion rate (CVR), the number of clicks, and a return on advertising spend (ROAS). An example of the advertising effect prediction device 10 is an information processing device such as a server device.

The advertising effect prediction device 10 functionally includes an acquisition unit 11, a processing unit 12, a calculation unit 13, and an output unit 14.

The acquisition unit 11 is a functional unit that acquires advertisement information related to advertising content. The advertisement information includes one or more images included in the advertising content. The acquisition unit 11 acquires all images included in the advertising content by, for example, performing scraping on a uniform resource locator (URL) of the advertising content. As shown in FIG. 2, the acquisition unit 11 acquires one or more images in an arrangement order (display order) of the images in the advertising content. The acquisition unit 11 may set the arrangement order of the images in the source code of the advertising content as the arrangement order of the images in the advertising content.

The advertisement information may further include text included in the advertising content. Examples of text include the title of the advertising content and the body of the advertising content. The acquisition unit 11 may acquire the text included in the advertising content by, for example, performing scraping on the URL of the advertising content. The acquisition unit 11 may acquire the title of the advertising content from a memory (not shown).

The advertisement information may further include delivery information. The delivery information is information related to delivery of advertising content. The delivery information includes, for example, target information related to a delivery target person who is a delivery target, number-of-deliveries information related to the number of deliveries, and budget information related to a budget. Examples of the target information include a minimum age, a maximum age, and sex. Examples of the number-of-deliveries information include the number of deliveries for one week, the number of deliveries for each day of the week, and the number of deliveries for each hour. Examples of budget information include a budget per day and a budget per month. The acquisition unit 11 acquires delivery information from a memory (not shown), for example. Various types of information such as the URL, title, and delivery information of the advertising content are supplied from the outside, for example, and are stored in advance in a memory (not shown) for each advertising content.

The processing unit 12 is a functional unit that processes advertisement information. The processing unit 12 processes the advertisement information acquired by the acquisition unit 11 into a format that can be input to a prediction model described later. The processing unit 12 performs, for example, the following processing on the image. Since the size (number of pixels) of the image included in the advertising content varies, the processing unit 12 changes (resizes) the size (number of pixels) of each image to a predetermined size (number of pixels). Resizing of the image is performed using a known method.

When the number of images obtained from one advertising content is less than a specified number N (N is an integer of 2 or more), the processing unit 12 adds a dummy image to adjust the number of images to the specified number N. The processing unit 12 adds dummy image(s) corresponding to the shortage after the images obtained from the advertising content. That is, the dummy image(s) are arranged after the images, which are arranged ill the arrangement order, included in the advertising content.

The processing unit 12 uses, for example, a black image (an image in which all pixel values are 0) as a dummy image. The processing unit 12 may use the immediately preceding image as a dummy image, or may use an image obtained by averaging pixel values of a plurality of images included in advertising content as a dummy image. In order to improve the prediction accuracy, the type of the dummy image may be matched with the type of the dummy image used for learning of a prediction model M. For example, when the prediction model M is learned by using a black image as a dummy image, the processing unit 12 may use the black image as the dummy image. Similarly, when the prediction model M is learned by using the immediately preceding image as the dummy image, the processing unit 12 may use the immediately preceding image as the dummy image.

In the example shown in FIG. 2, an advertising content AC includes five images G1 to G5. The images G1 to G5 are arranged in the order of image G1, image G2, image G3, image G4, and image 05 from the top to the bottom of the advertising content AC. In this example, the specified number N is set to 6. In this case, the acquisition unit 11 acquires the images G1 to G5, and the processing unit 12 changes the size of each image to a predetermined size. In this example, the images G1 to G4 are reduced to be changed to images Gil to G14, and the image G5 is enlarged to be changed to an image G15. Further, the dummy image is added as an image G16 by the processing unit 12.

The processing unit 12 performs, for example, the following processing on the text. The processing unit 12 divides the text into words by performing morphological analysis, assigns an index to each word, and vectorizes each word. The processing unit 12 adjusts the number of characters of the text to a specified number. When the number of characters of the text is less than the specified number, the processing unit 12 performs padding (for example, adds 0) to adjust the number of characters of the text to the specified number. The processing unit 12 performs, for example, the following processing on the delivery information. The processing unit 12 normalizes the delivery information and vectorizes the normalized delivery information.

The calculation unit 13 is a functional unit that calculates an advertising effect of the advertising content based on the advertisement information. As shown in FIG. 3, the calculation unit 13 includes the prediction model M for predicting an advertising effect. The prediction model M is a machine learning model in which each piece of advertisement information is used as an explanatory variable and an advertising effect is used as an objective variable, and is configured by, for example, a neural network. The prediction model M is generated by performing machine learning. In the machine learning, for example, a set of advertisement information of an advertising content from which an actual measurement value of an advertising effect is obtained and the actual measurement value of the advertising effect is used as correct data. The prediction model M includes a model Mb for delivery information, a model Mi for image, a model Mt for text, and a combining model Mc.

The model Mb for delivery information receives (the feature of) the delivery information processed by the processing unit 12 as an input, and outputs the feature of the entire delivery information. The feature of the entire delivery information is, for example, an important portion in the entire delivery information. In the model Mb for delivery information, for example, processing is performed in the order of linear transformation, calculation using a rectified linear unit (ReLU) function, linear transformation, and calculation using a Tanh function.

The model Mi for image receives (the features of) the N images processed by the processing unit 12 as inputs, and outputs the feature of all the images. The feature of all the images is, for example, an important portion in all the images. In the present embodiment, the model Mi for image is configured by a convolutional long short-term memory (ConvLSTM). The convolutional LSTM is a recurrent neural network (RNN) in which a linear operation of the LSTM is replaced with a convolution operation. The LSTM is a neural network configured to sequentially receive, as an input, each element of time-series data in which a plurality of elements are arranged and to exert an influence of an element that has already been input on an output.

As shown in FIGS. 4 and 5, a convolutional LSTM 30 outputs a cell state Cₜ and an output hₜ at a time t from an input Xₜ at the time t and a cell state Cₜ₋₁ and an output hₜ₋₁ at a time (t-1) which is one time before the time t. Specifically, a forget gate 31 receives the input Xₜ and the output hₜ₋₁ and outputs an output fₜ. The forget gate 31 calculates the output fₜ by performing an operation represented by Equation (1) using a weight matrix W_{f}, a weight matrix R_{f}, and a bias b_{f}. The weight matrix W_{f}, the weight matrix R_{f}, and the bias b_{f} are set in advance in the convolutional LSTM 30. A convolution operation of convolving the input Xₜ with the weight matrix W_{f} is performed, and a convolution operation of convolving the output hₜ₋₁ with the weight matrix R_{f} is performed. A function σ(·) represents a sigmoid function.

[Equation 1]

fₜ=σ(W_{f}*Xₜ+R_{f}*hₜ₋₁+b_{f}) (1)

An input gate 32 receives the input Xₜ and the output hₜ₋₁ and outputs an output iₜ. The input gate 32 calculates the output iₜ by performing an operation represented by Equation (2) using a weight matrix Wᵢ, a weight matrix Rᵢ, and a bias bᵢ. The weight matrix Wᵢ, the weight matrix Rᵢ, and the bias bᵢ are set in advance in the convolutional LSTM 30. A convolution operation of convolving the input Xₜ with the weight matrix Wᵢ is performed, and a convolution operation of convolving the output hₜ₋₁ with the weight matrix Rᵢ is performed.

[Equation 2]

iₜ=σ(Wᵢ*Xᵢ+Rᵢ*hᵢ₋₁+bᵢ) (2)

A tanh layer 33 receives the input Xₜ and the output hₜ₋₁ and outputs a vector C′ₜ of state values. The tanh layer 33 calculates the vector C′ₜ of the state values by performing an operation represented by Equation (3) using a weight matrix W_{c}, a weight matrix R_{c}, and a bias b_{c}. The weight matrix W_{c}, the weight matrix R_{c}, and the bias b_{c} are set in advance in the convolutional LSTM 30. A convolution operation of convolving the input Xₜ with the weight matrix W_{c} is performed, and a convolution operation of convolving the output hₜ₋₁ with the weight matrix R_{c} is performed.

[Equation 3]

C′ₜ=tanh(W_{c}*Xₜ+R_{c}*hₜ₋₁+b_{c}) (3)

In nodes 34 to 36, an operation represented by Equation (4) is performed to obtain the cell state Cₜ. Specifically, in the node 34, the information in the cell state Cₜ₋₁ is selected by multiplying the cell state Cₜ₋₁ by the output fₜ. The output fₜ has values within a range of 0 to 1 with respect to all values of the cell state Cₜ₋₁. When the value of the output fₜ is 1, the value of the cell state Cₜ₋₁ is completely maintained, and when the value of the output fₜ is 0, the value of the cell state Cₜ₋₁ is completely removed. Similarly, in the node 35, the state values in the vector C′ₜ are scaled by multiplying the vector C′ₜ by the output it. The output it has values within a range of 0 to 1 with respect to all values of the vector C′ₜ. In the node 36, the cell state Cₜ is obtained by adding the operation result of the node 34 and the operation result of the node 35.

[Equation 4]

Cₜ=Cₜ₋₁×fₜ+C′ₜ×iₜ (4)

An output gate 37 receives the input Xₜ and the output hₜ₋₁ and outputs an output oₜ. The output gate 37 calculates the output oₜ by performing an operation represented by Equation (5) using a weight matrix Wₒ, a weight matrix Rₒ, and a bias bₒ. The weight matrix Wₒ, the weight matrix Rₒ, and the bias bₒ are set in advance in the convolutional LSTM 30. A convolution operation of convolving the input Xₜ with the weight matrix Wₒ is performed, and a convolution operation of convolving the output hₜ_i with the weight matrix Rₒ is performed.

[Equation 5]

oᵢ=σ(Wₒ*Xₜ+Rₒ*hₜ₋₁+bₒ) (5)

In a tanh layer 38 and a node 39, the output hₜ is obtained by performing an operation represented by Expression (6). Specifically, the tanh layer 38 receives the cell state Cₜ and applies a tanh function to the cell state Cₜ to bring each value within a range of −1 to 1. In the node 39, the output hₜ is obtained by multiplying the output of oₜ by the operation result of the tanh layer 38. Each time the input Xₜ is input to the convolutional LSTM 30, the above processing is repeated. Although the N convolutional LSTM 30 are connected in series in FIG. 4, it schematically shows that an image is recursively input to one convolutional LSTM 30.

[Equation 6]

hₜ=oₜ×tanh(Cₜ) (6)

Here, the calculation unit 13 arranges the N images received from the processing unit 12 in the order of arrangement in the advertising content, and sequentially inputs the first image (feature thereof), the second image (feature thereof), . . . , and the N-th image (feature thereof) to the convolutional LSTM 30 (model Mi for image) as input X₁, input X₂, . . . , and input X_{N}, respectively. The model Mi for image outputs an output h_{N} as a feature of all the images.

The model Mt for text receives the text processed by the processing unit 12 as an input, and outputs a feature of the entire text. The feature of the entire text is, for example, an important portion in the entire text. In the model Mt for text, for example, processing is performed in the order of embedding, convolution, calculation using a ReLU function, MaxPooling, and calculation using a ReLU function.

The combining model Mc receives an output of the model Mb for delivery information, an output of the model Mi for image, and an output of the model Mt for text as inputs, and outputs an advertising effect. In the combining model Mc, for example, processing is performed in the order of batch normalization, dropout, linear transformation, calculation using a ReLU function, linear transformation, calculation using a Tanh function, linear transformation, and calculation using a sigmoid function.

As described above, the calculation unit 13 calculates the advertising effect by inputting the N images into the convolutional LSTM 30 one by one in the arrangement order of the N images in the advertising content.

The output unit 14 is a functional unit that outputs information indicating an advertising effect. For example, the output unit 14 may output information indicating an advertising effect to a display device (not shown) and cause the display device to display the advertising effect.

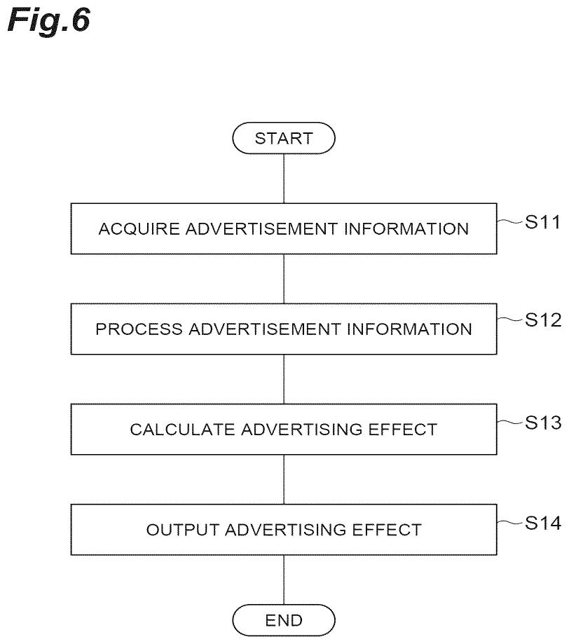

Next, an advertising effect prediction method performed by the advertising effect prediction device 10 will be described with reference to FIG. 6. FIG. 6 is a flowchart showing a series of processes of an advertising effect prediction method performed by the advertising effect prediction device shown in FIG. 1. The series of processes shown in FIG. 6 is started, for example, when the user sets, in the advertising effect prediction device 10, information capable of specifying advertising content that is a target for which an advertising effect is predicted.

As shown in FIG. 6, first, the acquisition unit 11 acquires advertisement information (step S11). In step S11, the acquisition unit 11 acquires, for example, all images included in the advertising content, a title of the advertising content, and delivery information of the advertising content as the advertisement information. Then, the acquisition unit 11 outputs the advertisement information to the processing unit 12.

Subsequently, the processing unit 12 processes the advertisement information (step S12). In step S12, upon receiving the advertisement information from the acquisition unit 11, the processing unit 12 processes the advertisement information into a format that can be input to the prediction model M. For example, the processing unit 12 changes the size of each image to a predetermined size, and when the number of images obtained from one advertising content is less than the specified number N, the processing unit 12 adds dummy image(s) to adjust the number of images to the specified number N. The processing unit 12 divides the text into words by performing morphological analysis, assigns an index to each word, and vectorizes each word. The processing unit 12 normalizes the delivery information and vectorizes the normalized delivery information. Then, the processing unit 12 outputs the processed advertisement information to the calculation unit 13.

Subsequently, the calculation unit 13 calculates an advertising effect of the advertising content (step S13). In step S13, upon receiving the processed advertisement information from the processing unit 12, the calculation unit 13 inputs the processed advertisement information to the prediction model M. Specifically, the calculation unit 13 inputs the processed delivery information to the model Mb for delivery information, inputs the processed N images to the model Mi for image, and inputs the processed text to the model Mt for text. The calculation unit 13 inputs the N images to the convolutional LSTM 30 of the model Mi for image one by one in the order of arrangement in the advertising content. The combining model Mc receives the output of the model Mb for delivery information, the output of the model Mi for image, and the output of the model Mt for text as inputs, and outputs an advertising effect. Then, the calculation unit 13 outputs information indicating the advertising effect to the output unit 14.

Subsequently, the output unit 14 outputs the advertising effect (step S14). In step S14, upon receiving the information indicating the advertising effect from the calculation unit 13, the output unit 14 outputs the information indicating the advertising effect to, for example, a display device (not shown) and causes the display device to display the advertising effect.

Thus, the series of processes of the advertising effect prediction method is completed.

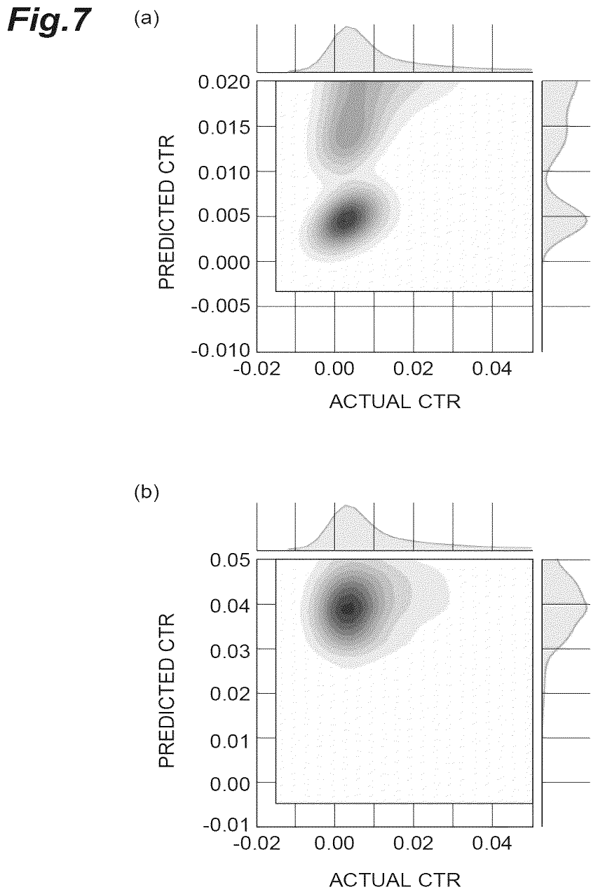

Next, the operation and effect of the advertising effect prediction device 10 will be described with reference to FIGS. 7(a) and 7(b). FIG. 7(a) is a diagram showing a relationship between the CTR predicted by the advertising effect prediction device shown in FIG. 1 and the actual CTR. FIG. 7(b) is a diagram showing a relationship between the CTR predicted by an advertising effect prediction device of a comparative example and the actual CTR. The advertising effect prediction device of the comparative example is mainly different from the advertising effect prediction device 10 in that the model Mi for image of the prediction model M is configured by a residual network (Resnet) instead of the convolutional LSTM, and in that the model Mi for image receives only a head image included in the advertising content as an input instead of all images included in the advertising content. The learning rate is 1e-6 for both the advertising effect prediction device and the advertising effect prediction device of the comparative example.

As shown in FIG. 7(b), the predicted CTR predicted by the advertising effect prediction device of the comparative example is larger than the actual CTR. The prediction accuracy (mean squared error) by the advertising effect prediction device of the comparative example was 4.57e-4. On the other hand, as shown in FIG. 7(a), the predicted CTR predicted by the advertising effect prediction device 10 is closer to the actual CTR than the advertising effect prediction device of the comparative example. The prediction accuracy (mean squared error) by the advertising effect prediction device 10 was 3.12e-4. Therefore, in the advertising effect prediction device 10, the mean square error is reduced by about 32% compared to the advertising effect prediction device of the comparative example.

In the advertising effect prediction device 10 described above, the advertising effect is calculated based on the arrangement order of the plurality of images in the advertising content. It is considered that the delivery target person who receives the delivery of the advertising content views the advertising content in order from the head of the advertising content. Therefore, there is a high possibility that the plurality of images included in the advertising content are within the field of view of the delivery target person in the arrangement order in the advertising content. In such a case, it is considered that the arrangement order of the images affects the interest of the delivery target person. In the advertising effect prediction device 10, since the advertising effect is predicted in consideration of the arrangement order of the plurality of images in the advertising content, it is possible to improve the prediction accuracy of the advertising effect of the advertising content. That is, according to the advertising effect prediction device 10, since both the element of the number of images and the element of the quality of the advertising content can be expressed as the feature, it is possible to improve the prediction accuracy of the advertising effect of the advertising content. By accurately predicting the advertising effect, it is possible to set an appropriate submission price for the advertising content.

The calculation unit 13 includes the prediction model M which is a machine learning model in which advertisement information is used as an explanatory variable and an advertising effect is used as an objective variable. Therefore, the advertising effect can be obtained only by inputting the advertisement information to the prediction model M.

The calculation unit 13 calculates an advertising effect by inputting a plurality of images included in advertising content to the convolutional LSTM 30 one by one in the arrangement order. According to this configuration, the influence of the already input image can be exerted on the output while capturing the feature of the image. Therefore, the arrangement order of the plurality of images included in the advertising content can be considered, and the prediction accuracy of the advertising effect can be improved.

The specified number N of images are input to the prediction model M. Therefore, when the number of images included in the advertising content is less than the specified number N, the processing unit 12 adjusts the number of images to the specified number N by adding dummy image(s). According to this configuration, since the number of images is made to match the input of the prediction model M, it is possible to appropriately perform prediction using the prediction model M. When the number of images exceeds a certain number, it is considered that the advertising effect such as the click rate greatly changes (increases). The number may vary depending on the media using the advertising content. Therefore, it is possible to extract the influence of the number of images on the advertising effect as the feature by measuring in advance the number of images in which the advertising effect greatly changes and setting the specified number N to the number of images (or the number of images or more). According to this configuration, whether or not the advertising content includes the specified number N or more of images can be reflected in the advertising effect. Furthermore, in the present embodiment, since a convolution operation is performed on each input image in the prediction model M, an important region in the image can be extracted. Therefore, it is possible to extract the influence of the quality of the image included in the advertising content on the advertising effect as the feature. As a result, it is possible to further improve the prediction accuracy of the advertising effect.

The viewpoint of the delivery target person may stop at the last image among the plurality of images included in the advertising content. As described above, it is considered that the impression of the image immediately before the position where the dummy image is inserted greatly affects the interest of the delivery target person. Therefore, in a case where an image immediately before the dummy image is used as the dummy image, it is possible to further improve the prediction accuracy of the advertising effect for the delivery target person who performs the browsing operation as described above.

After the delivery target person finishes browsing the advertising content, the delivery target person may look over the entire advertising content. The operation of looking over the entire advertising content can be represented in a pseudo manner by averaging pixel values of a plurality of images included in the advertising content. Therefore, when an image obtained by averaging the pixel values of the plurality of images included in the advertising content is used as the dummy image, it is possible to further improve the prediction accuracy of the advertising effect for the delivery target person who performs the browsing operation as described above.

The processing unit 12 changes the number of pixels of the plurality of images to a predetermined number of pixels. By equalizing the number of pixels of a plurality of images to the same number of pixels, each image can be handled under the same conditions. Therefore, it is possible to appropriately perform prediction using the prediction model M. As a result, it is possible to further improve the prediction accuracy of the advertising effect.

Not only the image included in the advertising content but also the text may attract the interest of the delivery target person. When the advertisement information further includes text included in the advertising content, the advertising effect may be predicted by further considering the text. Therefore, it is possible to further improve the prediction accuracy of the advertising effect.

It is considered that whether or not the delivery target person is attracted to the advertising content is determined to some extent by the title of the advertising content (subject of the advertisement mail). When the advertisement information includes the title of the advertising content as text, the advertising effect may be predicted by further considering the title of the advertising content. Therefore, it is possible to further improve the prediction accuracy of the advertising effect.

Although embodiments of the present disclosure have been described above, the present disclosure is not limited to the above-described embodiments.

The advertising effect prediction device 10 may be configured by a single device coupled physically or logically, or may be configured by two or more devices that are physically or logically separated from each other. For example, the advertising effect prediction device 10 may be implemented by a plurality of computers distributed over a network such as cloud computing. As described above, the configuration of the advertising effect prediction device 10 may include any configuration that can realize the functions of the advertising effect prediction device 10.

The advertising effect prediction device 10 does not have to include the processing unit 12. The acquisition unit 11 may acquire only images included in advertising content as advertisement information, or may acquire at least one of delivery information and text in addition to the images as advertisement information. The prediction model M does not have to include at least one of the model Mb for delivery information and the model Mt for text depending on the acquired advertisement information.

When the number of images obtained from one advertising content is less than the specified number N, the processing unit 12 may add dummy image(s) at an arbitrary position instead of after the images, which are arranged in the arrangement order, included in the advertising content.

The model Mi for image may be configured by a convolutional neural network (CNN) and an LSTM instead of the convolutional LSTM 30. For example, each image is input to the CNN, and the output of the CNN for each image is input to the LSTM in the arrangement order of the images in the advertising content. Thus, the feature in consideration of all the images and the arrangement order is obtained.

Note that the block diagrams used in the description of the above embodiments show blocks of functional units. These functional blocks (components) are realized by any combination of at least one of hardware and software. The method for realizing each functional block is not particularly limited. That is, each functional block may be realized using a single device coupled physically or logically. Alternatively, each functional block may be realized using two or more physically or logically separated devices that are directly or indirectly (e.g., by using wired, wireless, etc.) connected to each other. The functional blocks may be realized by combining the one device or the plurality of devices mentioned above with software.

Functions include judging, deciding, determining, calculating, computing, processing, deriving, investigating, searching, confirming, receiving, transmitting, outputting, accessing, resolving, selecting, choosing, establishing, comparing, assuming, expecting, considering, broadcasting, notifying, communicating, forwarding, configuring, reconfiguring, allocating, mapping, assigning, and the like. However, the functions are not limited thereto. For example, a functional block (component) for performing transmission is referred to as a transmitting unit or a transmitter. As explained above, the method for realizing any of the above is not particularly limited.

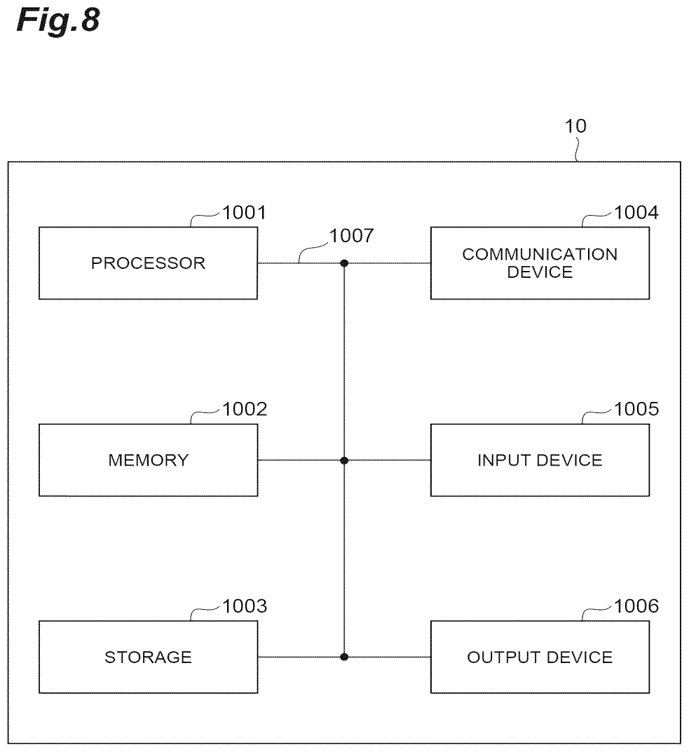

For example, the advertising effect prediction device 10 according to one embodiment of the present disclosure may function as a computer performing the processes of the present disclosure. FIG. 8 is a diagram showing an example of the hardware configuration of the advertising effect prediction device according to one embodiment of the present disclosure. The above-described advertising effect prediction device 10 may be physically configured as a computer device including a processor 1001, a memory 1002, a storage 1003, a communication device 1004, an input device 1005, an output device 1006, a bus 1007, and the like.

In the following description, the term “device” can be read as a circuit, a device, a unit, etc. The hardware configuration of the advertising effect prediction device 10 may be configured to include one or more of each device shown in the figure, or may be configured not to include some of the devices.

Each function of the advertising effect prediction device 10 is realized by causing the processor 1001, by loading predetermined software (program) onto hardware such as the processor 1001 and the memory 1002, to perform computation to control the communication via the communication device 1004 and to control at least one of reading data from and writing data to the memory 1002 and the storage 1003.

The processor 1001 operates, for example, an operating system to control the entire computer. The processor 1001 may be configured by a central processing unit (CPU) including an interface with a peripheral device, a controller, an arithmetic unit, a register, and the like. For example, each function of the above-described advertising effect prediction device 10 may be realized by the processor 1001.

The processor 1001 reads a program (program code), a software module, data, and the like from at least one of the storage 1003 and the communication device 1004 into the memory 1002, and executes various processes in accordance with these. As the program, a program for causing a computer to execute at least a part of the operations described in the above-described embodiments is used. For example, each function of the advertising effect prediction device 10 may be realized by a control program stored in the memory 1002 and operating in the processor 1001. Although it has been described that the various processes described above are executed by a single processor 1001, the various processes may be executed simultaneously or sequentially by two or more processors 1001. The processor 1001 may be implemented by one or more chips. The program may be transmitted from a network via a telecommunication line.

The memory 1002 is a computer-readable recording medium, and, for example, may be configured by at least one of a read only memory (ROM), an erasable programmable ROM (EPROM), an electrically erasable programmable ROM (EEPROM), a random access memory (RANI) and the like. The memory 1002 may be referred to as a register, a cache, a main memory (main storage) or the like. The memory 1002 can store executable programs (program codes), software modules, and the like for performing the advertising effect prediction method according to one embodiment of the present disclosure.

The storage 1003 is a computer-readable recording medium, and, for example, may be configured by at least one of an optical disc such as a compact disc ROM (CD-ROM), a hard disk drive, a flexible disk, a magneto-optical disc (e.g., a compact disc, a digital versatile disc, a Blu-ray (Registered Trademark) disc), a smart card, a flash memory (e.g., a card, a stick, a key drive), a floppy (Registered Trademark) disk, a magnetic strip, and the like. The storage 1003 may be referred to as an auxiliary storage. The recording medium described above may be, for example, a database, a server, or any other suitable medium that includes at least one of the memory 1002 and the storage 1003.

The communication device 1004 is hardware (transmission/reception device) for performing communication between computers through at least one of a wired network and a wireless network, and is also referred to as a network device, a network controller, a network card, a communication module, or the like. The communication device 1004 may include, for example, a high-frequency switch, a duplexer, a filter, a frequency synthesizer, and the like to realize at least one of frequency division duplex (FDD) and time division duplex (TDD). For example, the acquisition unit 11, the output unit 14, and the like described above may be realized by the communication device 1004.

The input device 1005 is an input device (e.g., a keyboard, a mouse, a microphone, a switch, a button, a sensor, or the like) that accepts input from the outside. The output device 1006 is an output device (e.g., a display, a speaker, an LED lamp, etc.) that performs an output to the outside. The input device 1005 and the output device 1006 may be integrated (e.g., a touch panel).

Devices such as the processor 1001 and the memory 1002 are connected to each other with the bus 1007 for communicating information. The bus 1007 may be configured using a single bus or using a separate bus for every two devices.

The advertising effect prediction device 10 may include hardware such as a microprocessor, a digital signal processor (DSP), an application specific integrated circuit (ASIC), a programmable logic device (PLD), and a field programmable gate array (FPGA). Some or all of each functional block may be realized by the hardware. For example, the processor 1001 may be implemented using at least one of such hardware components.

Notification of information is not limited to the aspects/embodiments described in the present disclosure, and may be performed using other methods.

In the processing procedures, sequences, flowcharts, and the like of each of the aspects/embodiments described in the present disclosure, the order of processing may be interchanged, as long as there is no inconsistency. For example, the methods described in the present disclosure present the various steps using exemplary order and are not limited to the particular order presented.

Information and the like may be output from an upper layer to a lower layer or may be output from a lower layer to an upper layer. Information and the like may be input and output via a plurality of network nodes.

The input/output information and the like may be stored in a specific location (e.g., a memory) or may be managed using a management table. The information to be input/output and the like can be overwritten, updated, or added. The output information and the like may be deleted. The input information and the like may be transmitted to another device.

The determination may be performed by a value (0 or 1) represented by one bit, a truth value (Boolean: true or false), or a comparison of a numerical value (for example, a comparison with a predetermined value).

The aspects/embodiments described in the present disclosure may be used separately, in combination, or switched with the execution of each aspect/embodiment. The notification of the predetermined information (for example, notification of “being X”) is not limited to being performed explicitly, and may be performed implicitly (for example, without notifying the predetermined information).

Although the present disclosure has been described in detail above, it is apparent to those skilled in the art that the present disclosure is not limited to the embodiments described in the present disclosure. The present disclosure may be implemented as modifications and variations without departing from the spirit and scope of the present disclosure as defined by the claims. Accordingly, the description of the present disclosure is for the purpose of illustration and has no restrictive meaning relative to the present disclosure.

Software, whether referred to as software, firmware, middleware, microcode, hardware description language, or other names, should be broadly interpreted to mean an instruction, an instruction set, a code, a code segment, a program code, a program, a subprogram, a software module, an application, a software application, a software package, a routine, a subroutine, an object, an executable file, an execution thread, a procedure, a function, etc.

Software, an instruction, information, and the like may be transmitted and received via a transmission medium. For example, if software is transmitted from a website, a server, or any other remote source using at least one of wired technologies (such as a coaxial cable, an optical fiber cable, a twisted pair, and a digital subscriber line (DSL)) and wireless technologies (such as infrared light and microwaves), at least one of these wired and wireless technologies is included within the definition of a transmission medium.

The information, signals, and the like described in the present disclosure may be represented using any of a variety of different technologies. For example, data, instructions, commands, information, signals, bits, symbols, chips, etc., which may be referred to throughout the above description, may be represented by voltages, electric currents, electromagnetic waves, magnetic fields or particles, optical fields or photons, or any combination thereof.

It should be noted that terms described in the present disclosure and terms necessary for understanding the present disclosure may be replaced with terms having the same or similar meanings.

The terms “system” and “network” as used in the present disclosure are used interchangeably.

The information, parameters, and the like described in the present disclosure may be expressed using absolute values, relative values from a predetermined value, or other corresponding information.

The names used for the parameters described above are in no way restrictive. Further, the mathematical expressions and the like using these parameters may be different from those explicitly disclosed in the present disclosure.

The term “determining” as used in the present disclosure may encompass a wide variety of operations. The “determining” may include, for example, judging, calculating, computing, processing, deriving, investigating, looking up, search, inquiry (e.g., searching in a table, a database, or another data structure), and ascertaining. The “determining” may include receiving (e.g., receiving information), transmitting (e.g., transmitting information), input, output, and accessing (e.g., accessing data in a memory). The “determining” may include resolving, selecting, choosing, establishing, and comparing. That is, the “determining” may include some operations that may be considered as the “determining”. The “determining” may include some operations that may be considered as the “determining”. The “determining” may be read as “assuming”, “expecting”, “considering”, etc.

The term “connected”, “coupled”, or any variation thereof means any direct or indirect connection or coupling between two or more elements. One or more intermediate elements may be present between two elements that are “connected” or “coupled” to each other. The coupling or connection between the elements may be physical, logical, or a combination thereof. For example, “connection” may be read as “access”. When “connect” or “coupling” is used in the present disclosure, the two elements may be considered to be “connected” or “coupled” to each other using one or more electrical wires, cables, printed electrical connections, and the two elements may be considered to be “connected” or “coupled” to each other using, as some non-limiting and non-exhaustive examples, electromagnetic energy having wavelengths in the radio frequency region, the microwave region, and light (both visible and invisible) regions.

The term “based on” as used in the present disclosure does not mean “based only on” unless otherwise specified. In other words, the term “based on” means both “based only on” and “based at least on”.

Any reference to an element using the designations “first”, “second”, etc., as used in the present disclosure does not generally limit the amount or order of the element. Such designations may be used in the present disclosure as a convenient way to distinguish between two or more elements. Thus, references to the first and second elements do not imply that only two elements may be adopted, or that the first element must precede the second element in any way.

The “unit” in the configuration of each of the above devices may be replaced with “circuit”, “device”, etc.

When “include”, “including”, and variations thereof are used in the present disclosure, these terms are intended to be inclusive, as well as the term “comprising”. Furthermore, the term “or” as used in the present disclosure is intended not to be an exclusive OR.

In the present disclosure, where article such as “a”, “an” and “the” in English is added by translation, the present disclosure may include that the noun following the article is plural.

In the present disclosure, the ten-n “A and B are different” may mean that “A and B are different from each other”. The term may mean that “each of A and B is different from C”. Terms such as “separated” and “combined” may also be interpreted in a similar manner to “different”.

### REFERENCE SIGNS LIST

10—advertising effect prediction device, 11—acquisition unit, 12—processing unit, 13—calculation unit, 14—output unit, 30—convolutional LSTM, 1001—processor, 1002—memory, 1003—storage, 1004—communication device, 1005—input device, 1006—output device, 1007—bus, M—prediction model, Mb—model for delivery information, Mc—combining model, Mi—model for image, Mt—model for text.

1. An advertising effect prediction device that predicts an advertising effect of advertising content, the advertising effect prediction device comprising:
an acquisition unit configured to acquire advertisement information related to the advertising content; and
a calculation unit configured to calculate the advertising effect based on the advertisement information,
wherein the advertisement information includes a plurality of images included in the advertising content, and
wherein the calculation unit calculates the advertising effect based on an arrangement order of the plurality of images in the advertising content.

2. The advertising effect prediction device according to claim 1,
wherein the calculation unit includes a prediction model that is a machine learning model in which the advertisement information is used as an explanatory variable and the advertising effect is used as an objective variable.

3. The advertising effect prediction device according to claim 2,
wherein the prediction model includes a convolutional LSTM, and
wherein the calculation unit calculates the advertising effect by inputting the plurality of images to the convolutional LSTM one by one in the arrangement order.

4. The advertising effect prediction device according to claim 2, further comprising a processing unit configured to process the advertisement information,
wherein when the number of the plurality of images is less than a specified number, the processing unit adjusts the number of the plurality of images to the specified number by adding a dummy image to the plurality of images.

5. The advertising effect prediction device according to claim 4,
wherein the dummy image is an image immediately preceding the dummy image.

6. The advertising effect prediction device according to claim 4,
wherein the dummy image is an image obtained by averaging pixel values of the plurality of images.

7. The advertising effect prediction device according to claim 4,
wherein the processing unit changes the number of pixels of the plurality of images to a predetermined number of pixels.

8. The advertising effect prediction device according to claim 1,
wherein the advertisement information further includes text included in the advertising content.

9. The advertising effect prediction device according to claim 8,
wherein the text is a title of the advertising content.

10. The advertising effect prediction device according to claim 3, further comprising a processing unit configured to process the advertisement information,
wherein when the number of the plurality of images is less than a specified number, the processing unit adjusts the number of the plurality of images to the specified number by adding a dummy image to the plurality of images.
